(19) United States
(12) Patent Application Publication
(10) Pub. No.: US 2008/0135489 A1
(43) Pub. Date: Jun. 12, 2008

(54) Solid Profile Filters Comprising Activated Carbon Fiber Rods and Methods of Making and Using Same

(75) Inventor: Bruce D. Saaski, CALDWELL, ID (US)

Correspondence Address: PEDERSEN & COMPANY, PLLC, P.O. BOX 2666, BOISE, ID, 83701, US

(73) Assignee: OMNIPURE FILTER COMPANY, INC., CALDWELL, ID (US)

(21) Appl. No.: 11/858,889

(22) Filed: Sep. 20, 2007

Related U.S. Application Data
(60) Provisional application No. 60/846,161, filed on Sep. 20, 2006.

(51) Int. Cl. C02F 1/42; B32B 9/00; B01D 39/00; B29C 65/00

(52) U.S. Cl. 210/688; 428/367; 210/502.1; 156/250

(57) ABSTRACT

Solid profile filter blocks for filtration of fluids include activated carbon fibers, preferably cut or ground into rod-shaped elements and bound into a solid profile using one or more binders. The filter block has internal structure and porosity that exhibit surprisingly-low pressure drop while effectively removing specific contaminants of interest. Granular activated carbon, lead or arsenic sorbents, and/or other active components may supplement the activated carbon fibers/rods in the present invention. The preferred manufacturing techniques preferably do not include any slurry process or other adding of water during the manufacturing process. The preferred cutting and/or grinding of longer, activated carbon source fibers into a range of rod lengths, including very short rods and longer rods, may be called a gross cut, as opposed to a precise cut that has a narrow distribution. Further, the resulting rod-like pieces or media components are shorter in length than prior art carbon fiber components used for water filter media, while still having aspect ratios and circular equivalent diameters that indicate that the preferred rods may not properly be considered spheres. The preferred distribution of cut and/or ground carbon fibers includes all or substantially all of the resulting rod lengths being less than 100 μm and the majority of the rods being in the lower part of that range, for example, greater than 50% of the rods being in the range of 1-10 μm length.

This application claims priority of Provisional Application Ser. No. 60/846161, filed Sep. 20, 2006, the entire disclosure of which is incorporated herein by this reference.

### BACKGROUND OF THE INVENTION

1. Field of the Invention

The present invention relates to media for fluid filtration and, more specifically, media that are formed into solid profiles, which may also be called “filter blocks.” The preferred filter blocks comprise activated carbon fibers and binder(s) combined in an economical manufacturing process that utilizes fewer steps than prior art processes. The carbon fibers may be activated prior to, or after, entering the invented manufacturing process. A cutting and/or sizing step may be used to obtain a distribution of activated carbon fiber sizes and shapes that, once bound into the solid profile, has been found to be very effective for the removal of various contaminants, such as chlorine, lead, etc., and for other filtration tasks, at reasonable pressure drops. Therefore, embodiments of the invention may be desirable in gravity-flow or other low-pressure systems where obtaining reasonable flow-rates through filter media is typically a problem.

2. Related Art

Activated carbon fibers have been disclosed as a component for solid profile filters, in such patents as Jagtoyen, et al. U.S. Pat. No. 6,852,224, issued Feb. 8, 2005. Jagtoyen, et al. disclose a water slurry method of making a carbon fiber block, wherein isotropic pitch-based carbon fibers are cut to a length range from 100-1000 μm in length, and an average length of 200 μm. The cut fibers are mixed in a water slurry with a binder such as phenolic resin, transferred to a tank, and partially dewatered by vacuum or air pressure. The resulting green form is partially dried, and then cured (for example, at 130 degrees C.). Following these steps, the cured body is carbonized under inert gas to pyrolize the resin binder, and then is activated by steam, carbon dioxide or chemical activation.

Activated carbon fibers have been disclosed as a component for a packed mixture of granules and fibers, in Shmidt, et al., issued Oct. 9, 2001. Shmidt, et al. disclose a composite filter block that includes granular activated carbon (GAC) and activated carbon fiber, mixed together and packed in a filter bed. This non-solid-profile composite uses 100-2000 μm carbon granules (more preferably 200-1000 μm carbon granules), and activated carbon fibers in the range of 1-30 μm diameter (preferably 4-20 μm, diameter) and 0.2 mm-20 mm length (200 μm,-20,000 μm).

Still, there is a need for an improved solid profile filter block, especially one that exhibits desirable characteristics for low-pressure or gravity-flow processes. Such desirable characteristics include low pressure drop across the filter block (which should result in greater flow rates at a defined influent pressure), consistent flow rates, and excellent contaminant removal per unit volume. The inventors also believe there is also a need for an improved method of manufacture of such an activated carbon fiber filter block.

### BRIEF DESCRIPTION OF THE DRAWINGS

FIGS. 1A-E are views (front, side, top, bottom, and axial cross-section, respectively) of one embodiment of a solid profile filter block that may be made by compositions of the invention.

FIGS. 2A-E are views (perspective, front, top, bottom and axial cross-section, respectively) of another embodiment of a solid profile filter block that may be made by compositions of the invention.

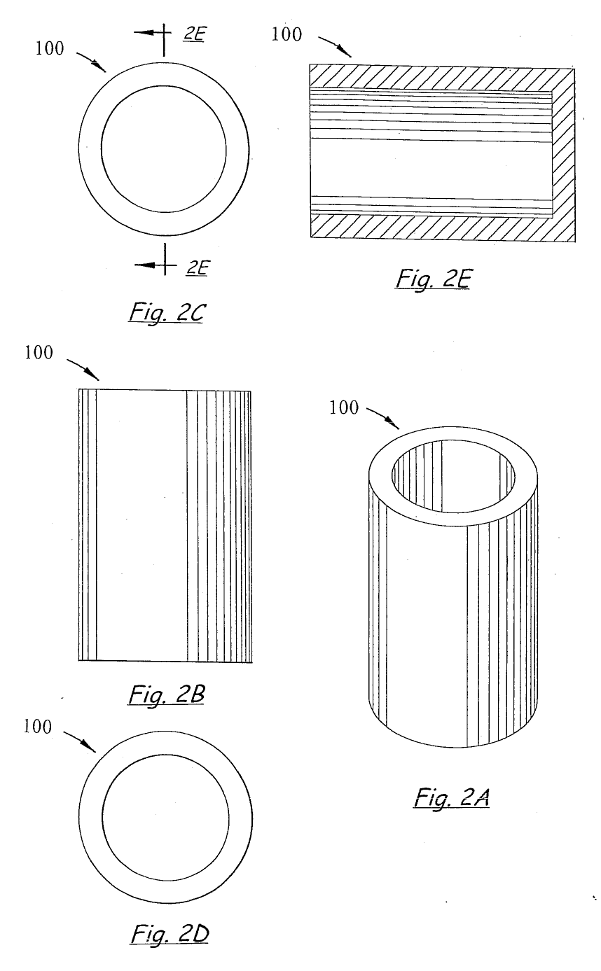

FIGS. 3A and 3B are images from Example I, wherein FIG. 3A shows a selection of particles from Sample 1, and wherein FIG. 3B shows a selection of longer fibers pieces from Sample 1.

FIGS. 4A and 4B are images from Example I, wherein FIG. 4A shows a selection of particles from Sample 2 that comprises mostly extremely small fragments, and wherein FIG. 4B shows a selection of fragments that are called “more typical” of Sample 2.

FIGS. 5A and 5B are images from Example I, wherein FIG. 5A shows a selection of particles from Sample 3, and wherein FIG. 5B shows views used to study width of the particles of Sample 3.

FIG. 6 is a graph of graph percentage (left axis) of Sample 1 vs. circular equivalent diameter and also percentage of the respective sample that is undersize (right axis) vs. the circle equivalent diameter (CE).

FIG. 7 is a graph of graph percentage (left axis) of Sample 2 vs. circular equivalent diameter and also percentage of the respective sample that is undersize (right axis) vs. the circle equivalent diameter (CE).

FIG. 8 is a graph of graph percentage (left axis) of Sample 3 vs. circular equivalent diameter and also percentage of the respective sample that is undersize (right axis) vs. the circle equivalent diameter (CE).

FIG. 9 portrays generally how circle equivalent diameter (CE) is calculated in the field of particles measurement and analysis.

### SUMMARY OF THE INVENTION

The present invention comprises solid profile compositions of matter for filtration of fluids, and methods of manufacturing and using the same. It is envisioned that the invented compositions of matter and methods may be effective for filtration and/or treatment of water, air, and other liquids and gases. The invented filter blocks comprise carbon fibers, preferably cut or ground into rod-shaped elements, which are then bound into a solid profile using one or more binders. The carbon fibers are preferably activated prior to being cut or ground into the rod-shaped elements, but may also be activated after being cut or ground and/or after being bound into a solid profile. The resulting solid profile filter block has internal structure and porosity that may exhibit surprisingly-low pressure drop while effectively removing specific contaminants of interest. Embodiments of the invention are expected to be effective in meeting lead removal mandates, such as the recent NSF Standard 53 for lead in drinking water, and effective in removing/reducing both dissolved and particulate lead. Further, the invented filter blocks may be effective in gravity-flow and low-pressure applications (less than 60 psi, for example).

The special length and diameter distribution of the desired rod-shaped carbon fiber elements used in the preferred embodiments is believed to provide excellent contact between contaminated water and media while also establishing an internal structure/porosity that allows flow without substantial pressure drop. Activated carbon source fibers, from which the preferred rod-shaped carbon fiber elements may be cut or ground or otherwise formed, may be acquired from various commercial providers of activated carbon fibers. Especially-preferred activated carbon source fibers may be made according to the disclosure of PCT Publication WO 2004/099073, entitled “Process for the Production of Activated Carbon,” by Inventor Jean-Pierre Farant, and Applicant McGill University of Montreal, which publication is hereby incorporated herein by this reference.

### DETAILED DESCRIPTION OF THE PREFERRED EMBODIMENTS

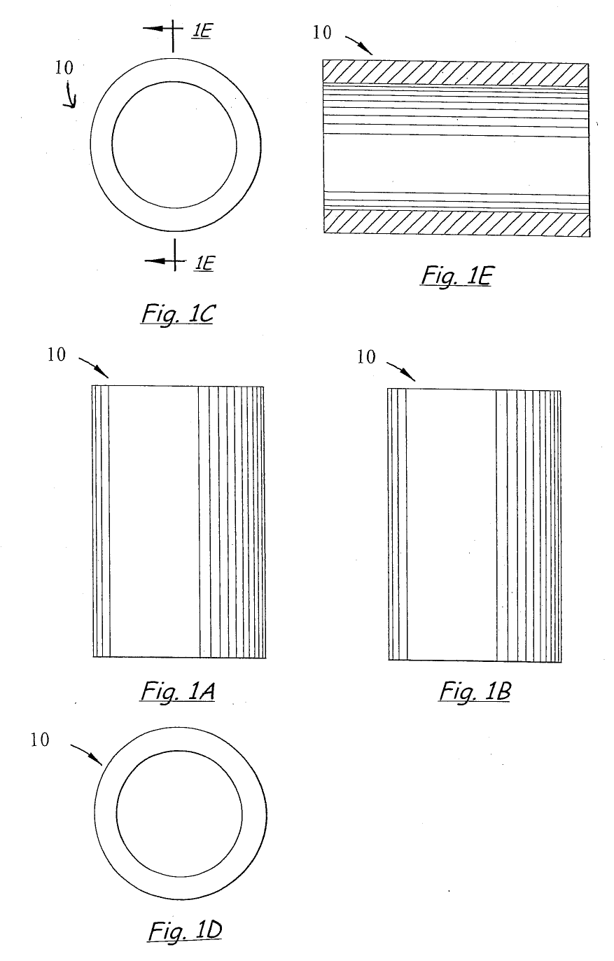

Referring to FIGS. 1A-E and 2A-E, there are shown some, but not the only, embodiments of filter blocks that may be made according to the compositions and methods of the invention. These filter blocks 10, 100 are a tubular and a cup-shaped filter block, respectively, but the inventor envisions that many filter shapes, molded or otherwise, may be effective. Filters according to the invention may be used in many different fluid filtration or treatment flow schemes as will be apparent to one of skill in the art after viewing this disclosure.

The preferred filter blocks are comprised of carbon fibers, preferably cut or ground into rod-shaped elements, which are then bound into a solid profile using one or more binders. Preferably, the carbon fibers are activated prior to being cut or ground, or activated after being cut or ground but before being bound into the solid profile, in order to maximize consistency and thoroughness of the activation process. Granular or powdered activated carbon, lead or arsenic sorbents, and/or other active components may supplement the activated carbon fibers/rods in the preferred embodiments. Percentages of the activated carbon fiber or fiber rods, supplemental active materials, and binder(s) may differ greatly, but, in many embodiments, the percentages of the components would be in the range of:

| | | |
|---|---|---|
| a) | activated carbon fiber (preferably in the form | 30-95 wt % |
| | of rod-shaped elements cut/ground from | |
| | activated carbon source fibers): | |
| b) | supplemental active materials, including GAC, | 0-45 wt % |
| | lead sorbent such as Alusil ™ | |
| | or ATS ™, arsenic sorbent, for example: | |
| c) | binder(s): | 5-50 wt % |

wherein these components would be adjusted relative to each
other to total 100 wt-% of the mixture.

The preferred manufacturing techniques are simpler than those suggested by the prior art, and do not include any slurry process or other adding of water during the manufacturing process. The moisture from ambient air may contact and reside in some of the components and/or the mixture of rods and binder, but water is not added as a purposeful step in the preferred procedures. Further, the preferred methods of the present invention involve the source carbon fibers being activated before being mixed with, or otherwise contacted by, the binder(s), and, preferably, being activated before the preferred cutting and/or grinding step. The preferred embodiments do not comprise dewatering/water removal (except that some moisture in the materials from ambient conditions may be driven off during heating), do not require curing of a green body, do not require the binder to be pyrolized, and do not require carbon fiber activation after forming of the solid body. The prior art step of contacting the filter block with steam, carbon dioxide, or other activation chemicals is not required and preferably is not done.

Various binders may be used, with preferred binders being polymeric, thermo-set, and/or polyethylene binders and, particularly, binders of low melt index. Preferred binders are those with less than a 5 g/min melt index, or less than a 1 g/min melt index by ASTM D1238 or DIN 53735 at 190 degrees C. and 15 kilograms. Particularly preferred binders have a melt index (ASTM D1238 or DIN 53735 as above) of less than or equal to 0.1 g/min.

The rod-shaped elements of the preferred embodiments may be produced by various cutting and/or grinding techniques, including a method that has been proven in the laboratory, which is the use of a conventional “kitchen-style” blender. The cutting and/or grinding technique and equipment is not limited to the laboratory blender, or to other rotating high-speed single or multiple-blade cutting head, but these are examples of the many different cutting mechanisms that may be used to produce what may be called the desired “gross” cut of rod-like shapes of the preferred embodiments. The preferred cutting/grinding methods cut the activated carbon fibers transversely, rather than longitudinally, and preferably do not “smash” the fibers.

The preferred cutting and/or grinding of longer, activated carbon source fibers into a range of rod lengths, including very short rods and longer rods, may be called a gross cut, as opposed to a precise cut that has a narrow distribution. Further, the resulting rod-like pieces or media components are shorter in length than prior art carbon fiber components used in the past for water filter media, while still having aspect ratios and circular equivalent diameters that indicate that the preferred rods may not properly be considered spheres (therefore, are non-spherical).

The preferred distribution of cut and/or ground carbon fibers includes all (100 percent) or substantially all (greater than 90 percent and more preferably greater than 95 percent) of the resulting rod lengths being less than 100 μm and the majority of the rods being in the lower part of that range, for example, greater than 50% of the rods being in the range of 1-10 μm length. For example, when rods are cut/ground from activated carbon fiber source material in the range of 10-16 μm diameter, said rods may have a length mean of less than 20 μm, a width mean of less than 10 μm, and a circular equivalent diameter mean in the range in the range of 6-10. One example of a desirable distribution for activated carbon rods according to the invention is: circular equivalent diameter D10 in the range of 1.5-2 μm, D50 in the range of 3-5 μm, and D90 in the range of 15-30 μm.

### EXAMPLE I

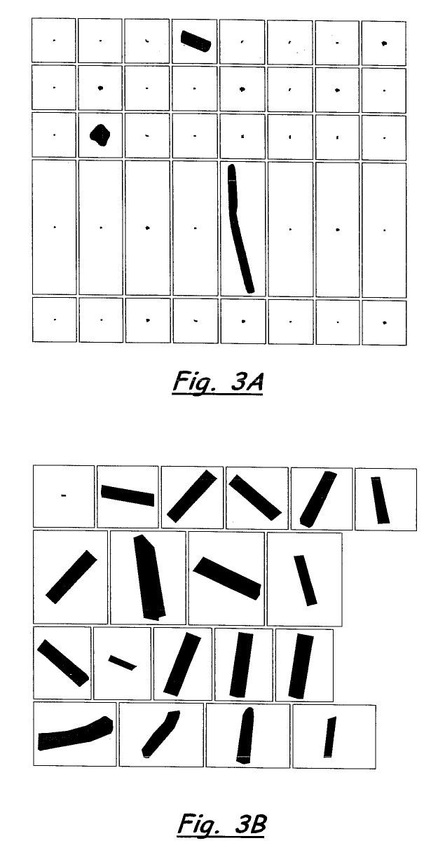

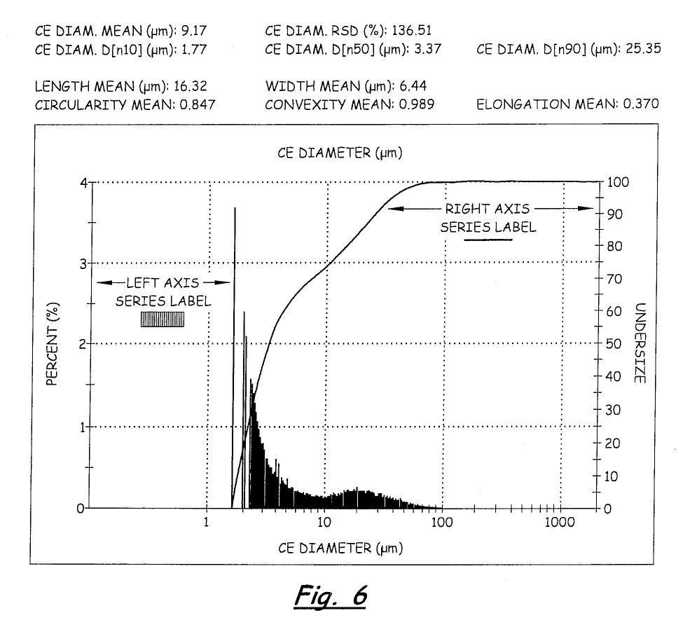

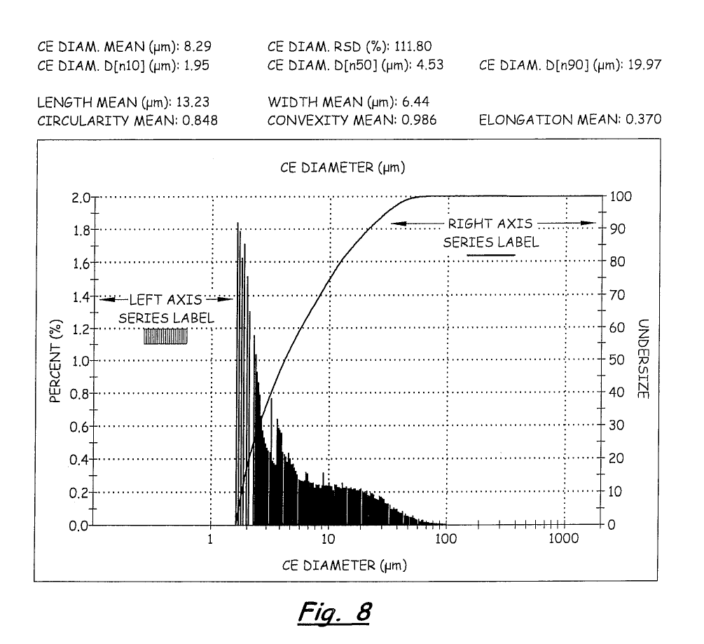

Referring to FIGS. 3A-8, there are shown size and shape distribution for some, but not the only, embodiments of the invention. Analysis of three samples of activated carbon fiber rods according to preferred embodiments of the invention was conducted by the Applicant through Malvern Instruments of Southborough, Mass., USA. These samples were derived by grinding three samples of approximately 13 μm diameter activated carbon source fiber, wherein the activated carbon source fiber was reported by the supplier to have been made according to methods in PCT Publication WO 2004/099073, entitled “Process for the Production of Activated Carbon.” Note that methods included in this PCT Publication comprise one or more carbon fiber materials being a dehydrated carbon precursor material made from a starting cellulosic material, wherein the dehydrated carbon precursor material is made by subjecting said cellulosic material to a dehydration stage whereby water is eliminated from the structure of the cellulosic material, wherein the dehydration stage comprises a dehydration heating step comprising heating the cellulosic material, in the presence of a dehydration stage treatment agent, at a dehydration temperature below 220 degrees C. for a time period sufficient so as to obtain said dehydrated carbon precursor material, and wherein said dehydration stage treatment agent is selected from the group consisting of polar solvent soluble phosphorous containing inorganic Lewis Acid compounds and mixtures thereof. Said heating of the cellulosic material in many of these methods are described as being done in the range of from 120 to 200 degrees C. Said dehydration stage treatment agent is described as comprising a member selected from the group consisting of phosphoric acid, polyphosphoric acid, pyrophosphoric acid, metaphosphoric acid and mixtures thereof.

The three samples were prepared by grinding the activated carbon source fibers in a kitchen-style laboratory grinder until the ground material had the naked-eye appearance of a powder (fine particles rather than short fibers). The three samples were given the labels Sample 1, Sample 2, Sample 3, and were submitted for size and shape analysis by Malvern Instruments.

FIGS. 3A and B, 4A and B, and 5A and B are images of portions of Samples 1, 2, and 3 respectively, taken from large amount of data from dispersing the samples on a glass plate at 8 Bar injector pressure, in accordance with the Malvern standard procedures. While FIGS. 3A-5B portray only a few particles for each sample, the Malvern standard procedures included the steps of counting

The FIG. 3A image of Sample 1 illustrates that the sample comprised a mixture of fibrous material (the long pieces) plus many broken fragments. The FIG. 3B image focuses on the longer fibers pieces in the sample, which retain the diameter of the source (starting) carbon fibers, but are much shorter than the course carbon fibers.

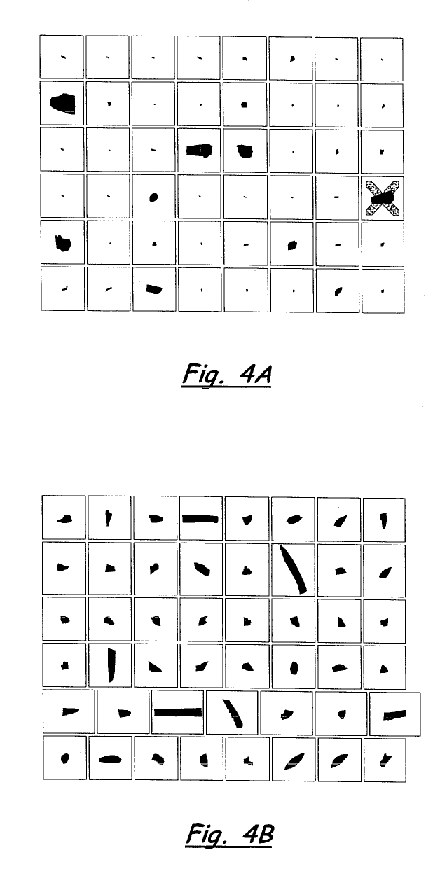

The FIGS. 4A and B images of Sample 2 illustrates that Sample 2 comprised more broken fragments than Sample 1, as evidenced by the mixture of very small fragments and larger fragments, and fewer longer fibrous pieces being in the images.

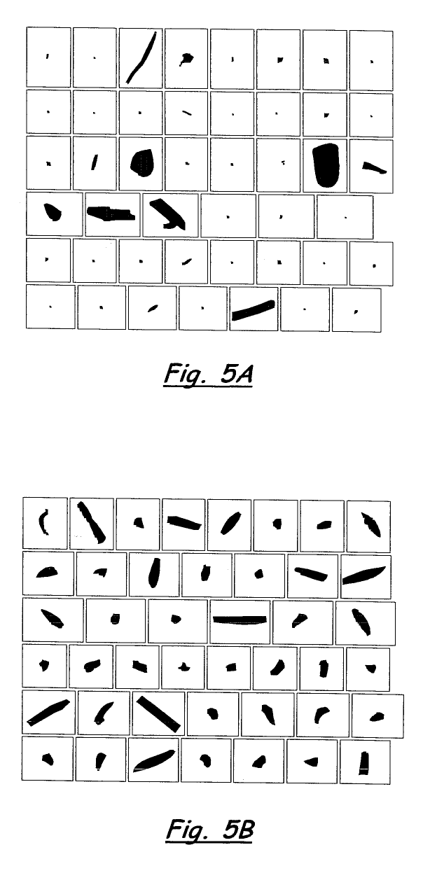

The FIGS. 5A and B images of Sample 3 illustrate that Sample 3 had less “chards” than Sample 2 but particle widths not as “clean” as those in Sample 1.

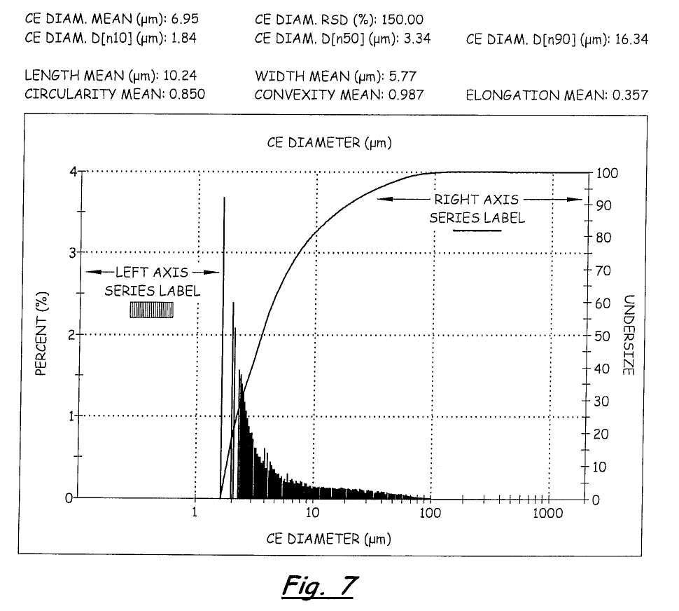

FIGS. 7, 8, and 9 each graph percentage (left axis) of Sample 1, 2, and 3, respectively, vs. circle equivalent diameter and also percentage of the respective sample that is undersize (right axis) vs. the circle equivalent diameter.

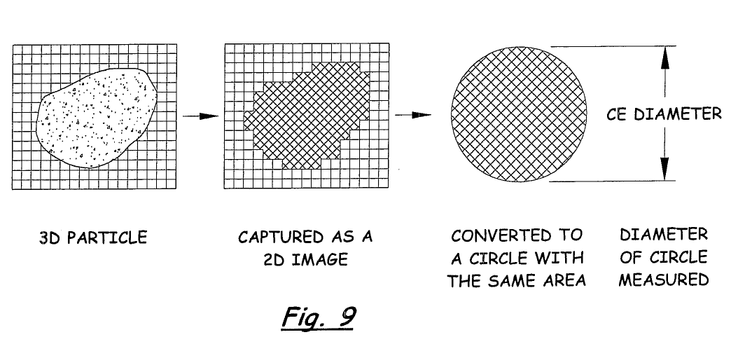

Note that in this data from Malvern Instruments, definitions of circle/circular equivalent diameter are used that are standard to this type of testing and well-known in the industry. For example, in this type of testing, image analysis captures a two dimensional (2D) image of a 3D particle and calculates various size and shape parameters from the 2D image. One of the parameters that is calculated is Circle-Equivalent (CE) Diameter, the diameter of a circle with the same area as the 2D image of the particle. Particle shape, of course, influences this CE diameter, but it is at least a single number that gets larger or smaller as the particle does and is objective and repeatable. The 3D image of the particle is captured as a 2D image and converted to a circle of equivalent area to the 2D image. The diameter of this circle is then reported as the CE diameter of that particle, as illustrated in FIG. 9.

The conclusions drawn from the size and distribution testing in this Example were that all of the samples contained a proportion of fibers (same or similar diameter compared to the strating/source activated carbon fibers but much shorter) with a mass of fragments, with the mass of fragments dominating the number distribution. Sample 1 had the “cleanest” fibers at about 13 micron in diameter. The fibers in Sample 2 and 3 were rougher than Sample 1. Sample 3 had particles that were both longer and wider on average than Sample 2.

When solid profile filter blocks were made from the above samples, by mixing the samples with binder, and molding and heating as described below, the filter blocks made from activated carbon source fiber “Sample 1” and “Sample 3” performed best in tests of reduction of chlorine and lead in water. Some filter solid profile filter blocks produced from activated carbon source fiber “Sample 2” cracked when wet with water.

### Exhibit II

Starting with the same or similar activated carbon source fibers as did the samples in Example I, the source activated carbon fibers were cut into rod-shaped structures by using the laboratory blender in the same manner as in Exhibit I and, therefore, it was believed that the same or similar size and distribution of rod-shaped structures was achieved. The rod-shaped structures (also called “AC Fiber” in the following tables) were mixed with the binder (GUR 2122™ or GUR 2105™) in the proportions of 84 wt-% rod-shaped structure and 16 wt-% binder. The mixtures were then compressed (using a piston-style lid on the mold) to the extent that the mixture volume was reduced by about 10-20 percent. The mixtures in their respective molds were heated to 400-500 degrees F., over a period of about 30 minutes. Each mold and its contents were then cooled and the resulting filter blocks were removed from the molds. Then, the resulting filter blocks were tested for chlorine removal, as indicated in Table 1 below.

Also, a filter block made as described above (the test data of which is in Table 1) was compared to another filter block made of solely granular activated carbon and binder. The granular activated carbon filter block was made according to a formula of GAC (80×325 U.S. Standard Mesh coconut shell base activated carbon, called “HMM 80×320”) and binder (GUR 2105™) but no activated carbon rods (no activated carbon fibers or ground/cut activated carbon fiber rods were included).

The results of chlorine removal testing of the two filter blocks is shown in Table 2, below. By about midway in the testing, the block comprising activated carbon rod-shaped elements was still achieving greater than 98 percent chlorine removal (noted as the “R” data), but the filter block comprising granular activated carbon (but not containing the rod-shaped elements made by grinding the carbon fibers) was allowing chlorine to break through (evidenced by only 83-95 percent chlorine removal, in the “G” data).

Also, testing for lead removal capability was conducted for a formulation comprising GAC, activated carbon rods made according to the discussion in Example I, Alusil™ lead removal media, and GUR 2122™ binder. See Table 3, below, which shows high levels of removal of total lead and also particulate lead being achieved by filter blocks of this type.

TABLE 1
Product: CL6 Activated Carbon Fiber Blocks

| | Weight | Lot | | | | Fill | Pressed |
|---|---|---|---|---|---|---|---|
| Formulation | Percent | Number | d (0.1) | d (0.5) | d (0.9) | Weight (g) | Length (in) |
| AC Fiber | 84 | | | | | Below | 8.5 |
| GUR 2122 | 16 | | | | | | |

ACB Vol. @8.5″ L: cm 3

Chlorine Reduction Data Carbon Fiber Media
Type #1 Sample #1 and Sample #2

| | | Eff. Chlorine | | Eff. Chlorine | |
|---|---|---|---|---|---|
| Volume | Inf. Chlorine | Level Sample #1 | Pct. | Level Sample #2 | Pct. |
| (Gals) | Level (mg/L) | (mg/L) | Reduction | (mg/L) | Reduction |
| Initial | 2.15 | <0.05 | >98 | <0.05 | >98 |
| 250 | 2.06 | <0.05 | >98 | <0.05 | >98 |
| 500 | 2.14 | <0.05 | >98 | <0.05 | >98 |
| 750 | 2.17 | <0.05 | >98 | <0.05 | >98 |
| 1000 | 2.00 | <0.05 | >98 | <0.05 | >98 |
| 1250 | 2.11 | <0.05 | >98 | <0.05 | >98 |
| 1500 | 2.23 | <0.05 | >98 | <0.05 | >98 |
| 1750 | 2.12 | <0.05 | >98 | <0.05 | >98 |
| 2000 | 2.20 | <0.05 | >98 | <0.05 | >98 |
| Average: | 2.13 | <0.05 | >98 | <0.05 | >98 |

Flow Rate: 0.5 GPM
Challenge: Spiked Caldwell tap-water.

TABLE 2

| | | | | | | | |
|---|---|---|---|---|---|---|---|
| | Weight | Lot | | | | Fill | Pressed |
| Formulation | Percent | Number | d (0.1) | d (0.5) | d (0.9) | Weight (g) | Length (in) |

Product: CL6 Activated Carbon Fiber Blocks

| | | | |
|---|---|---|---|
| AC Fiber | 84 | Below | 8.5 |
| GUR 2122 | 16 | | |

ACB Vol. @8.5″ L: cm 3

Product: CL6 Activated Carbon Blocks

| | | |
|---|---|---|
| HMM 80 × 325 | 82 | 8.5 |
| GUR 2105 | 18 | |

ACB Vol. @8.5″ L: cm 3

Product: CL6 Activated Carbon Fiber Blocks/CL6 Activated Carbon Block
Chlorine Reduction Data Carbon Fiber Media Type #1 Samples #3 and CL6 1M ACB

| | | Eff. Chlorine | | Eff. Chlorine | |
|---|---|---|---|---|---|
| Volume | Inf. Chlorine | Level Sample #3 | Pct. | Level CL6 1M ACB | Pct. |
| (Gals) | Level (mg/L) | (mg/L) | Reduction | (mg/L) | Reduction |
| Initial | 2.12 | <0.05 | >98 | <0.05 | >98 |
| 250 | 2.20 | <0.05 | >98 | <0.05 | >98 |
| 500 | 2.12 | <0.05 | >98 | <0.05 | >98 |
| 750 | 2.03 | <0.05 | >98 | <0.05 | >98 |
| 1000 | 2.00 | <0.05 | >98 | <0.05 | >98 |
| 1250 | 2.11 | <0.05 | >98 | <0.05 | >98 |
| 1500 | 2.02 | <0.05 | >98 | 0.17 | 92 |
| 1750 | 2.12 | <0.05 | >98 | 0.24 | 89 |
| 2000 | 2.09 | <0.05 | >98 | 0.35 | 83 |
| Average: | 2.09 | <0.05 | >98 | 0.25 | 95 |

Note:
Operating Cycle: 6 min. On/6 min. Off
Flow Rate: Maintained @ 0.50 GPM
Influent Challenge: Spiked Caldwell Tap-water

TABLE 3
LEAD REMOVAL DATA
Formula #13

| | Weight | Lot | | | |
|---|---|---|---|---|---|
| Formulation | Percent | Number | d (0.1) | d (0.5) | d (0.9) |
| Kuraray PGWH-100MP | 12 | I2 = 1400 | 8.816 | 91.899 | 193.279 |
| ACF | 36 | Type 3 | | | |
| Alusil 40-70 | 12 | | | | |
| GUR 2122 | 40 | | | | |

| | Block | Fill | Flow |
|---|---|---|---|
| Sample # | Weight (g) | Weight (g) | Min:Sec/L |
| 13-2 | 30.3 | 31.0 | 3:46 |

| Sample 13-2 | 3L(SU) | 76L | 151L | 227L | 273L |
|---|---|---|---|---|---|
| Effluent | 19.64 | 17.6 | 22.6 | | |
| Filtered | 17.02 | 19.17 | 7.52 | | |
| Influent | 160.7 | 153.1 | 152.9 | | |
| % Total Pb Removed | 87.8 | 88.5 | 85.2 | | |
| % Particulate Removed | 94.6 | 103.4 | 67.1 | | |
| Rig Flow Rate (min) | 5.47 | 5.24 | 4.53 | | |
| Omnipure Flow Rate (min | 3.46 | | | | |

| | Block | Fill | Flow |
|---|---|---|---|
| Sample # | Weight (g) | Weight (g) | Min:Sec/L |
| 13-6 | 31.2 | 32.5 | |

| Sample 13-6 | 3L(SU) | 76L | 151L | 227L | 273L |
|---|---|---|---|---|---|
| Effluent | 17.53 | 17.22 | 20.78 | | |
| Filtered | 15.11 | 15.85 | 20.3 | | |
| Influent | 161.2 | 158.5 | 155 | | |
| % Total Pb Removed | 89.1 | 89.1 | 86.6 | | |
| % Particulate Removed | 95.0 | 97.1 | 99.0 | | |
| Rig Flow Rate (min) | 6.34 | 6.16 | 5.47 | | |

| | Block | Fill | Flow |
|---|---|---|---|
| Sample # | Weight (g) | Weight (g) | Min:Sec/L |
| 13-4 | 31.4 | 32.0 | |

| Sample 13-4 | 3L(SU) | 76L | 151L | 227L | 273L |
|---|---|---|---|---|---|
| Effluent | 15.91 | 17.12 | | | |
| Filtered | 4.37 | 16.48 | | | |
| Influent | 185.2 | 151.8 | | | |
| % Total Pb Removed | 91.4 | 88.7 | | | |
| % Particulate Removed | 79.2 | 98.6 | | | |
| Rig Flow Rate (min) | 10.47 | 6.17 | 8.07 | | |

| | Block | Fill | Flow |
|---|---|---|---|
| Sample # | Weight (g) | Weight (g) | Min:Sec/L |
| 13-7 | 30.2 | 31.5 | |

| Sample 13-7 | 3L(SU) | 76L | 151L | 227L | 273L |
|---|---|---|---|---|---|
| Effluent | 18.97 | 18.34 | 23.04 | | |
| Filtered | 5.81 | 18.77 | 14.7 | | |
| Influent | 190.2 | 160.6 | 155.9 | | |
| % Total Pb Removed | 90.0 | 88.6 | 85.2 | | |
| % Particulate Removed | 76.9 | 100.9 | 32.2 | | |
| Rig Flow Rate (min) | 5.58 | 4.55 | 4.38 | | |

As will be understood from this disclosure and the Provisional Application disclosure incorporated herein, components, conditions, and steps other than those in the above Examples may be used. For example:

Activated carbon fibers, and/or granular/powered activated carbon mixed with said fibers, may be obtained from other sources than those described above, such as bituminous coal, coconut shell, lignite, wood, or other carbon sources. One may note that, in embodiments that include both activated carbon fibers (preferably rods cut/ground from longer, source activated carbon fibers) and granular/powered activated carbon, that the fibers and/or rods provide the materials having what may be called a non-spherical aspect ratio and the granules/powder provide material having what may be called a spherical or very close to spherical aspect ratio.

More or less compression could be used, with the preferred compression being from 0-50% volume reduction of the mixed media components. The compression may occur prior to heating, during heating and/or after heating. Alternatively, no compression may be used.

Lower temperatures and longer times could also be used in the heating step, as long as the binder(s) become appropriately tacky to “stick” the components of the mixture together. It is preferred that the heating step raises the binder to, or slightly above (up to about 20 degrees F. above), the melting point of the binder(s). Heating may be done by heating the mixture, or, less preferably, by heating the activated carbon fiber and/or granules prior to mixing with the binder(s).

Other shapes and sizes of activated carbon fibers and/or activated carbon rod-shaped structures may be used and/or other binders may be used.

The preferred solid profile filter may be called a “filter block” and may be described as three-dimensional rather than sheet-like or panel-like. For generally cylindrical blocks, the axial length is preferably 1-5 times the diameter, but, in some embodiments, may fall within a wider range of ⅓-5 or even ⅓-10 times the diameter of the filter block. For non-cylindrical blocks, the axial length is preferably within the range of 1-5 times the width and within the range of 1-5 times the depth, but, in some embodiments, may fall within the wider ranges of ⅓-5 or even ⅓-10 times the width and the depth. The invented compositions of matter may be effective for other shapes, for example, those that are generally two-dimensional rather than three-dimensional, that is, sheets or panels. Such sheets or panels typically may be characterized by having a width and length each greater than 10 times the thickness of the sheet, and may be particularly effective for filtration of air or other gases.

It is short pieces of fiber and fragments of fibers such as tested in Example I and made into filter blocks in Example II (which in general keep the same or close to the same diameter as the source carbon fiber but that are much shorter) that are called herein rods rather than carbon fibers. Applicants believe that the unusual size and distribution of size resulting from cutting or grinding the much-longer source fibers may be instrument in creating rod-shapes and sizes that are very effective in solid profile media blocks for water and other fluid filtration.

Although this invention has been described above, and in the attached Exhibits, with reference to particular means, materials and embodiments, it is to be understood that the invention is not limited to these disclosed particulars, but extends instead to all equivalents within the broad scope of the following Claims.

1. A solid profile filter block for fluid filtration comprising:
one or more activated carbon fiber materials;
at least one binder material mixed with said one or more activated carbon fiber materials and heated to, or slightly above, the melting point of the binder to bind said one or more activated carbon fiber materials together in a unitary solid profile form;
wherein at least one of said activated carbon fiber materials comprises rods having a length mean of less than 20 μm, a width mean of less than 10 μm, a circular equivalent diameter mean in the range in the range of 6-10.

2. A solid profile filter block as in claim 1, wherein said rods have a circle equivalent diameter D10 in the range of 1.5-2 μm, D50 in the range of 3-5μm, and D90 in the range of 15-30 μm.

3. A solid profile filter block as in claim 1, wherein 75-85 percent of said rods being between 2 and 10 μm circular equivalent diameter.

4. A solid profile filter block as in claim 1, wherein 10-25 percent of said rods have a circular equivalent diameter between 10-100 μm and the remainder of the rods have a circular equivalent diameter less than 10 μm.

5. A solid profile filter block according to claim 1, wherein all of said one or more activated carbon fiber materials are activated prior to being mixed with said at least one binder.

6. A solid profile filter block according to claim 1, wherein said rods are formed by cutting a longer activated carbon source fiber transversely relative to the length of the source fiber.

7. A solid profile filter block according to claim 1, wherein said rods are formed by a gross cutting of a longer activated carbon source fiber to obtain said length mean, said width mean, and said circular equivalent diameter mean.

8. A solid profile filter block according to claim 1, wherein at least or said at least one binder is selected from the group consisting of thermoplastic binder, thermoset binder, polyolefins, polyethylene, polyvinyl halides, polyvinyl esters, polyvinyl ethers, polyvinyl sulfates, polyvinyl phosphates, polyvinyl amines, polyamides, polyimides, polyoxidiazoles, polytriazols, polycarbodiimides, polysulfones, polycarbonates, polyethers, polyarylene oxides, polyesters, polyarylates, phenol-formaldehyde resins, melamine-formaldehyde resins, formaldehydeureas, ethyl-vinyl acetate copolymers, co-polymers and block interpolymers thereof, and derivatives and combinations thereof.

9. A solid profile filter block according to claim 1, wherein at least one of said at least one binder has a melt index of less than or equal to 0.1 g/min melt index by ASTM D1238 or DIN 53735 at 190 degrees C. and 15 kilograms.

10. A solid profile filter block according to claim 1, selected from the group selected from: a three-dimensional block, and a sheet having a width and a length each greater than 10 times the dimension of the thickness of the sheet.

11. A solid profile filter block according to claim 1, wherein the block is a hollow cylinder.

12. A solid profile filter block according to claim 1, wherein said at least one binder deforms to cover less than 10 percent of the surface area of said one or more carbon fiber materials.

13. A solid profile filter block according to claim 1, wherein the mixture of said one or more carbon fiber material and said at least one binder is compressed during said heating to increase contact between said at least one binder and said rods.

14. A solid profile filter block according to claim 1, wherein the mixture of said one or more carbon fiber material and said at least one binder is compressed before said heating to increase contact between said at least one binder and said rods.

15. A solid profile filter block according to claim 1, wherein mixture of said one or more carbon fiber material and said at least one binder is compressed after said heating to increase contact between said at least one binder and said rods.

16. A solid profile filter block according to claim 1, wherein the rods are substantially transverse to the longest dimension of said filter block.

17. A solid profile filter block according to claim 1, further comprising at least one additional active component selected from the group consisting of: lead sorbent and arsenic sorbent.

18. A solid profile filter block for fluid filtration consisting essentially of:
one or more activated carbon fiber materials;
at least one binder material mixed with said one or more activated carbon fiber materials and heated to, or slightly above, the melting point of the binder to bind said one or more activated carbon fiber materials together in a unitary solid profile form;
wherein at least one of said activated carbon fiber materials consists of rods having a length mean of less than 20 μm, a width mean of less than 10 μm, a circular equivalent diameter mean in the range in the range of 6-10.

19. A solid profile filter block for fluid filtration consisting of:
one or more activated carbon fiber materials;
one or more lead sorbent materials;
at least one binder material mixed with said one or more activated carbon fiber materials and said one or more lead sorbent materials and heated to, or slightly above, the melting point of the binder to bind said one or more activated carbon fiber materials and said one or more lead sorbent materials together in a unitary solid profile form;
wherein at least one of said activated carbon fiber materials consists of rods having a length mean of less than 20 μm, a width mean of less than 10 μm, a circular equivalent diameter mean in the range in the range of 6-10.

20. A solid profile filter block for fluid filtration consisting of:
one or more activated carbon fiber materials;
one or more arsenic sorbent materials;
at least one binder material mixed with said one or more activated carbon fiber materials and said one or more lead arsenic materials and heated to, or slightly above, the melting point of the binder to bind said one or more activated carbon fiber materials and said one or more arsenic sorbent materials together in a unitary solid profile form;
wherein at least one of said activated carbon fiber materials consists of rods having a length mean of less than 20 μm, a width mean of less than 10 μm, a circular equivalent diameter mean in the range in the range of 6-10.

21. A composition of matter comprising:
at least one activated carbon fiber material cut and/or ground to provide rod-shaped activated carbon fiber pieces having a length mean of less than 20 μm, a width mean of less than 10 μm, a circular equivalent diameter mean in the range in the range of 6-10.

22. A composition of matter comprising:
activated carbon fibers cut and/or ground to provide rod elements, said rod elements having rod lengths less than 100 μm, and greater than 50% of the rods being in the range of 1-10 μm length.

23. A composition of matter comprising:
activated carbon fibers cut and/or ground to provide rod elements, said rod elements having circular equivalent diameter D10 in the range of 1.5-2 μm, D50 in the range of 3-5 μm, and D90 in the range of 15-30 μm.

24. A solid profile filter block for fluid filtration comprising activated carbon rods cut from longer carbon fiber source material by cutting and/or grinding said source material;
at least one binder material mixed with said rods and heated to deform or melt to hold said rods together to form said media block;
wherein no water, other than water from ambient air, is added to said activated carbon rods, to said at least one binder, or to said mixture during manufacture of said media block.

25. A solid profile filter block for fluid filtration as in claim 24, wherein neither said at least one binder nor the mixture is heated to an extent wherein said binder will pyrolize.

26. A solid profile filter block for fluid filtration as in claim 24, wherein said activated carbon rods are not exposed to a carbon activation step after being mixed with said at least one binder.

27. A solid profile filter block for fluid filtration comprising activated carbon rods cut from longer carbon fiber source material;
at least one binder material mixed with said rods and heated to deform or melt to hold said rods together to form said media block;
wherein no water, other than water from ambient air, is added to said activated carbon fiber, to said at least one binder, or to said mixture, prior, during, or after said mixing and heating.

28. A method of making a filter block:
providing an activated carbon fiber material;
cutting said activated carbon fiber material into rods;
mixing said rods with at least one binder to obtain a mixture; and
heating said mixture to at least the softening point of said binder;
the method not comprising adding any water, other than moisture from ambient air, to said rods, or to said binder, or to said mixture.

29. A method of making a filter block:
providing an activated carbon fiber material;
cutting said activated carbon fiber material into rod;
heating said rods; and
mixing said rods with at least one binder to obtain a mixture; and
wherein said heating of the rods is done to a temperature above the softening point of said binder;
the method not comprising adding any water, other than moisture from ambient air, to said rods, or to said binder, or to said mixture.

29. The method of claim 29, wherein said cutting results in greater than 99% of said rods being less than 100 μm in length.

30. The method of claim 29, wherein said cutting is a gross cutting that results in distribution of rods between 1-100 μm in length, with greater than 50 percent of said rods having a length between 1-10 μm in length.

31. The method of claim 29, wherein said activated carbon fiber material comprises fibers in the range of 10-16 μm diameter and said cutting results in rods having a length mean of less than 20 μm, a width mean of less than 10 μm, a circular equivalent diameter mean in the range in the range of 6-10.

32. The method of claim 29, wherein said rods have a circular equivalent diameter D10 in the range of 1.5-2 μm, D50 in the range of 3-5 μm, and a D90 in the range of 15-30 μm.

33. The method of claim 29, wherein said rods have a circular equivalent diameter distribution with 75-85 percent of said rods being between 2 and 10 μm circular equivalent diameter.

34. The method of claim 29, wherein said rods have a circular equivalent diameter distribution wherein 10-25 percent of said rods have a circular equivalent diameter between 10-100 μm and the remainder of the rods have a circular equivalent diameter less than 10 μm.

35. The method of claim 29, wherein said activated carbon fiber material is activated prior to being cut into said rods.

36. The method of claim 29, wherein said binder has a melt index of less than or equal to 0.1 g/min melt index by ASTM D1238 or DIN 53735 at 190 degrees C. and 15 kilograms.

37. A method of filtering water and removing lead from said water, the method comprising:
providing the media blocks of claim 1 in a gravity-flow device;
presenting unfiltered water to said media block; and
allowing water to flow through said device and said media block under gravity flow to filter the water and remove soluable and particulate lead.
